(19) United States
(12) Patent Application Publication
(10) Pub. No.: US 2021/0049659 A1
(43) Pub. Date: Feb. 18, 2021

(54) SYSTEM AND METHOD FOR CREATING AN ONLINE EXCHANGE BETWEEN LODGING SEEKERS AND LODGING PROVIDERS FOR NEGOTIATING THE PRICE OF ROOMS

(71) Applicant: Mehmet Melih Bas, Marmaris (TR)

(72) Inventor: Mehmet Melih Bas, Marmaris (TR)

(21) Appl. No.: 16/165,926

(22) Filed: Oct. 19, 2018

Related U.S. Application Data
(63) Continuation of application No. 15/967,470, filed on Apr. 30, 2018.
(60) Provisional application No. 62/492,181, filed on Apr. 29, 2017.
(60) Provisional application No. 62/532,630, filed on Jul. 14, 2017.

(51) Int. Cl. G06Q 30/06; G06Q 10/02; G06Q 50/12; G06Q 50/18

(52) U.S. Cl. CPC G06Q 30/0611; G06Q 10/02; G06Q 30/0623; G06Q 50/188; G06Q 30/0641; G06Q 50/12

(57) ABSTRACT

A system and method for providing an online exchange where customers and hotels can negotiate the price for specific rooms is provided. The system and method is web-based, and allows customers and hotels to access information and tools for dynamically negotiating the price of specific hotel rooms. The system and method provides real-time or near real-time information to customers and hotels regarding the supply and demand for rooms (e.g., rooms available, current asking price for rooms, alternative price offers for rooms by customers, price being offered by competing hotels, etc.), thereby creating a real-time or near real-time market for hotel rooms, similar to a securities market in which the price of securities are determined based on market dynamics.

This application is a continuation-in-part of U.S. patent application Ser. No. 15/967,470, filed Apr. 30, 2018, which claims priority to U.S. Provisional Application Ser. No. 62/532,630, filed Jul. 14, 2017, and U.S. Provisional Application Ser. No. 62/492,181, filed Apr. 29, 2017. The entire disclosures of the above-identified applications are incorporated herein by reference.

### BACKGROUND OF THE INVENTION

### 1. Field of the Invention

The present invention relates to online lodging booking systems and, more specifically, an online lodging booking system that creates an online exchange where lodging seekers and lodging providers can negotiate the price of specific rooms.

### 2. Background of the Related Art

The terms “lodging provider” and “hotel” are used interchangeably and refer to a provider of paid lodging (hereinafter also referred to as “hotel room”). The terms “lodging seeker” and “customer” are used interchangeably and refer to individuals seeking paid lodging.

There are many online web sites for booking hotel rooms. Typically, hotel booking websites purchase blocks of reservations from hotels and then list them on their websites. Examples of such websites include EXPEDIA.COM, TRAVELOCITY.COM and HOTELS.COM. These websites publish set prices for rooms and customer is not able to negotiate for the price of a room. In addition, hotels can also list available rooms on their own websites. The prices published for rooms on the hotel's website are set and not open to negotiation.

Some hotel booking websites, such as PRICELINE.COM, utilize a “reverse auction” system, in which a customer makes a monetary bid for a hotel room. However, in such reverse auctions systems, the customer is not able to bid on a specific hotel room. Rather, the customer makes a bid for a hotel room located in some general location that offers a certain service level (e.g., a three star hotel or a four star hotel). The exact identity of the hotel offering the hotel room is only disclosed after a hotel has accepted the customer's bid.

### SUMMARY OF THE INVENTION

An object of the invention is to solve at least the above problems and/or disadvantages and to provide at least the advantages described hereinafter.

Therefore, an object of the present invention is to provide an online hotel room exchange.

Another object of the present invention is to provide an online hotel room exchange in which customers and hotels can dynamically negotiate the price of specific hotel rooms.

Another object of the present invention is to provide an online hotel room exchange in which customers and hotels can dynamically negotiate the price of specific hotel rooms, in which customers are provided with the identity and location of hotels prior to the customer initiating a negotiation process for a room at a specific hotel.

Another object of the present invention is to provide an online hotel room exchange in which customers and hotels can dynamically negotiate the price of specific hotel rooms, and in which the customers can accept a room rate being offered by a hotel or offer a different room rate for the hotel.

Another object of the present invention is to provide an online hotel room exchange in which customers and hotels can dynamically negotiate the price of specific hotel rooms, and in which a room rate set by a hotel cannot be changed by the hotel until a predetermined period of time has elapsed.

Another object of the present invention is to provide an online hotel room exchange in which customers and hotels can dynamically negotiate the price of specific hotel rooms, and in which hotels accumulate offers from customers over a predetermined period of time and adjust their room rate based, at least in part, on the offers made by customers.

Another object of the present invention is to provide an online hotel room exchange in which customers and hotels can dynamically negotiate the price of hotel rooms, and in which hotels are provided with information regarding the room rates being offered by competing hotels.

Another object of the present invention is to provide an online hotel room exchange in which customers and hotels can dynamically negotiate the price of hotel rooms, and in which customers that book hotel rooms from hotels via the online hotel room exchange can resale the bookings to other customers via the online hotel room exchange.

Another object of the invention is to provide a secondary market online hotel room exchange in which a customer that has booked a hotel room can resell the hotel room booking to another customer, and in which the price at which the hotel room booking is resold can be dynamically negotiated via the hotel room exchange.

Another object of the invention is to provide a secondary market online hotel room exchange in which a customer that has booked a hotel room can resell the hotel room booking to a travel business, and in which the price at which the hotel room booking is resold can be dynamically negotiated via the hotel room exchange.

To achieve at least the above objects, in whole or in part, there is provided a system for providing on online hotel room exchange, comprising a server and an exchange module comprising a set of computer readable instructions executable by the server to provide an online hotel room exchange between customers that have booked hotel rooms (“offering customers”) and customers seeking hotel rooms (“booking customers”) in which the offering customers and the booking customers can dynamically negotiate a resale price for booked hotel rooms, wherein the online hotel room exchange provides the booking customer with the identity and location of hotel rooms prior to the booking customer initiating a resale price negotiation process for a booked hotel room.

To achieve at least the above objects, in whole or in part, there is also provided a system for providing on online hotel room exchange, comprising a server and an exchange module comprising a set of computer readable instructions executable by the server to provide an online hotel room exchange between customers that have booked hotel rooms (“offering customers”) and travel businesses seeking hotel rooms (“travel businesses”) in which the offering customers and the travel businesses can dynamically negotiate a resale price for booked hotel rooms, wherein the online hotel room exchange provides the travel businesses with the identity and location of hotel rooms prior to the travel businesses initiating a resale price negotiation process for a booked hotel room.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram of a system for providing an online hotel room exchange, in accordance with one embodiment of the present invention;

FIG. 2A is a flow chart of a method for providing an online hotel room exchange, in accordance with one embodiment of the present invention;

FIG. 2B is a flow chart of a method 600 for providing a C2C online hotel room exchange, in accordance with one embodiment of the present invention;

FIG. 2C is a flow chart of a method 700 for providing a C2B online hotel room booking exchange, in accordance with one embodiment of the present invention;

FIG. 3 is a screenshot of a webpage presented to customers that includes a search function for searching available hotel rooms, in accordance with one embodiment of the present invention;

FIG. 4 is a screenshot of a webpage showing hypothetical results for a search in the Turkish city of Marmaris, in accordance with one embodiment of the present invention;

FIG. 5 is a screenshot of a webpage that shows information about a chosen hotel, in accordance with one preferred embodiment of the present invention;

FIG. 6 is a screenshot of a webpage that prompts the customer to enter the number of guests that will be staying, in accordance with one embodiment of the present invention;

FIG. 7 is a screenshot of a webpage that prompts the customer to indicate the number of rooms the need, in accordance with one embodiment of the present invention;

FIG. 8 is a screenshot of a webpage which prompts the customer to enter information for the guests that will be staying, in accordance with one embodiment of the present invention;

FIG. 9 is a screenshot of a webpage that shows reservation details, in accordance with one embodiment of the present invention;

FIG. 10 is a screenshot of a webpage that prompts the customer to provide their payment details, in accordance with one embodiment of the present invention;

FIG. 11 is a screenshot of a webpage showing a reservation confirmation that preferably includes the number of rooms, the number of nights booked, the check-in date and the check-out date, in accordance with one embodiment of the present invention; and

FIG. 12 is a screenshot of a webpage accessible by hotels for monitoring price offers for rooms, monitoring room bookings, setting the price for rooms, generating reports and obtaining other information regarding the market for rooms, in accordance with one embodiment of the present invention.

### DETAILED DESCRIPTION OF PREFERRED EMBODIMENTS

As indicated above, the terms “lodging provider” and “hotel” are used interchangeably and refer to a provider of paid lodging (hereinafter also referred to as “hotel room”). The terms “lodging seeker,” “customer” and “booking customer” are used interchangeably and refer to individuals seeking paid lodging. The term “offering customer” refers to an individual that has booked a hotel room and that is offering to resale the hotel room booking. The term “travel business” refers to a business in the travel industry including, but not limited to, travel agencies, tour operators and hotel room wholesalers.

In the following detailed description of various embodiments of the system and method of the present invention, numerous specific details are set forth in order to provide a thorough understanding of various aspects of one or more embodiments. However, the one or more embodiments may be practiced without some or all of these specific details. In other instances, well-known methods, procedures, and/or components have not been described in detail so as not to unnecessarily obscure aspects of embodiments.

While preferred embodiments are disclosed, still other embodiments of the system and method of the present invention will become apparent to those skilled in the art from the following detailed description, which shows and describes illustrative embodiments. As will be realized, the following disclosure is capable of modifications in various obvious aspects, all without departing from the spirit and scope of the present invention. Accordingly, the screenshot figures, and the detailed descriptions thereof, are to be regarded as illustrative in nature and not restrictive. Also, the reference or non-reference to a particular embodiment of the invention shall not be interpreted to limit the scope of the present invention.

In the following description, certain terminology is used to describe certain features of one or more embodiments of the invention. For instance, the terms “computer”, “computer system,” “server,” “customer device”, and “hotel device”, refer to any device that processes information with an integrated circuit chip, including without limitation, mainframe computers, workstations, servers, desktop computers, portable computers, laptop computers, embedded computers, wireless devices including cellular phones, tablet computers, personal digital assistants, digital media players, portable game players, and hand-held computers.

As used herein, the term “Internet” refers to any collection of networks that utilizes standard protocols, such as TCP/IP, Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application,” “software,” “software application” and/or “module” generally refer to any set of machine-readable instructions on a client machine, web interface, and/or computer system, that directs a computer's processor to perform specific steps, processes, or operations disclosed herein.

As used herein, the terms “webpage,” “page,” “website,” and/or “site” generally refers to any of the various documents and resources, typically hosted on a server and accessible via the World Wide Web, in HTML/XHTML format with hypertext links to enable navigation from one page or section to another, or similar such resources used on the Internet.

The present invention is a system and method for providing an online exchange where customers and hotels can negotiate the price for specific hotel rooms. The system and method is web-based, and allows customers and hotels to access information and tools for negotiating the price of hotel rooms in real-time or near real-time (a business to customer exchange (B2C)).

An aspect of the present invention is providing an online exchange in which real-time or near real-time information is provided to customers and hotels regarding the supply and demand for rooms (e.g., rooms available, current asking price for rooms, alternative price offers for rooms by customers, price being offered by competing hotels, etc.), thereby creating a real-time or near real-time market for specific hotel rooms. This is similar to a securities market in which the price of securities, such as stocks, are determined based on market dynamics. In the present invention, the price of a specific hotel room is determined based on a dynamic market in which both customers and hotels participate in real-time or near real-time and respond to supply and demand.

With the system and method of the present invention, customers are able to search for hotels by geographic area and/or price. Customers are then provided with a listing of hotels that include room rates that are set by respective hotels. Customers are given a choice of accepting the room rate currently being offered by the hotel, or offering a lower room rate to the hotel (“counteroffer”).

In one preferred embodiment, hotels are provided with all the counteroffers for their rooms and can then choose to lower the room rate based on supply and demand. As the hotel receives counteroffers from customers, it provides an important view of the current market for hotel rooms. The more counteroffers the hotel receives, the better the understanding of market conditions and the hotel can make a better determination as to whether the set room rate too high, too low or just right. In one preferred embodiment, the hotel is also provided with information regarding the room rates being offered by competing hotels so that a more accurate picture of market conditions is provided to hotels and so that hotels will compete among each other for customers.

In a preferred embodiment, the room rate set by the hotel cannot be changed for a predetermined period of time (e.g., 30 minutes). Thus, in this preferred embodiment, a hotel must wait for the predetermined period of time before changing the room rate. During this predetermined period of time, the hotel can continue to gather counteroffers from customers. Once the predetermined period of time has elapsed, the hotel can then change the rate based on market conditions determined by the counteroffers it has received and, optionally, by considering the room rates being offered by other hotels.

In one preferred embodiment, if the hotel lowers the room rate in response to market conditions (e.g., counteroffers, room rates being offered by other hotels), then all customer counteroffers that are equal to or higher than the new room rate set by the hotel are accepted at the new lower room rate set by the hotel. In addition, all other customers looking for hotel rooms are offered the same new lower room rate for that hotel.

Another aspect of the present invention is the ability to create a secondary market for hotel rooms. In one embodiment of the present invention, the online exchange is adapted such that hotel rooms that are booked by a customer can be resold by the customer to other customers via the online exchange (a customer to customer exchange (C2C)). In one embodiment, the hotel receives a percentage of revenues generated whenever a customer resells a booked hotel room to another customer via the online exchange. In another embodiment of the present invention, the online exchange is adapted such that hotel rooms that are booked by a customer can be resold by the customer to a travel business via the online exchange (a customer to business exchange C2B)). In one embodiment, the hotel receives a percentage of revenues generated whenever a customer resells a booked hotel room to travel business via the online exchange.

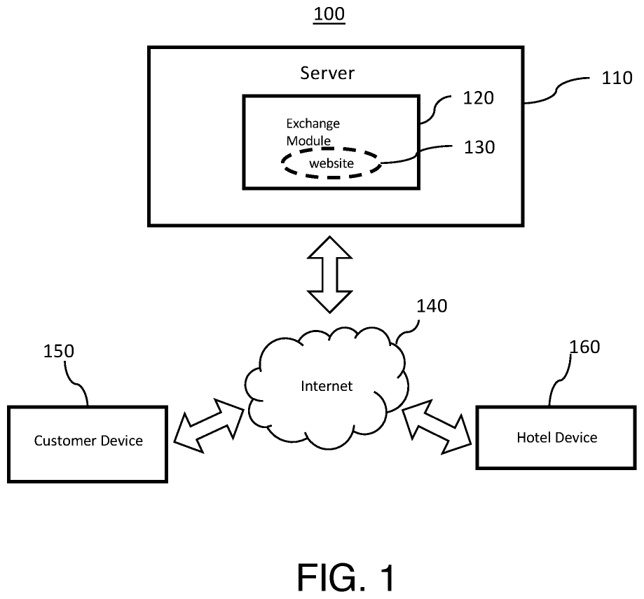

FIG. 1 is a block diagram of a system 100 for providing an online hotel room exchange, in accordance with one preferred embodiment of the present invention. The system 100 includes one or more servers 110 with an exchange module 120 that implements the hotel room exchange functionality that will be described in more detail below.

One of the functions of the exchange module 120 is to implement one or more websites 130 through which customers and hotels participate in the hotel room exchange, as will be described in more detail below. Customers and hotels communicate with the website 130 via the Internet 140 using a customer device 150 and hotel device 160, respectively.

The customer device 150 and hotel device 160 can be implemented with any device programmed with software that allows one to access the website 130 including, without limitation, mainframe computers, workstations, servers, desktop computers, portable computers, laptop computers, embedded computers, wireless devices including cellular phones, tablet computers, personal digital assistants, digital media players, portable game players, and hand-held computers.

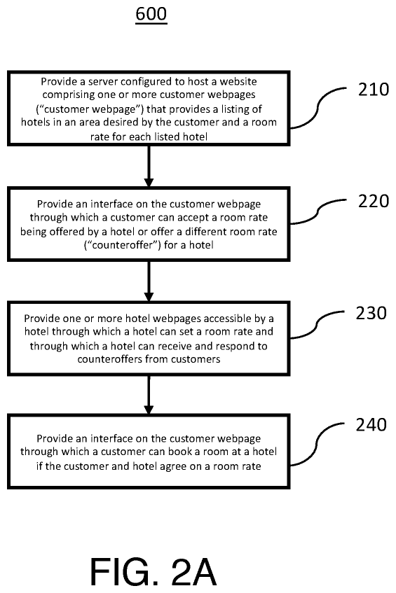

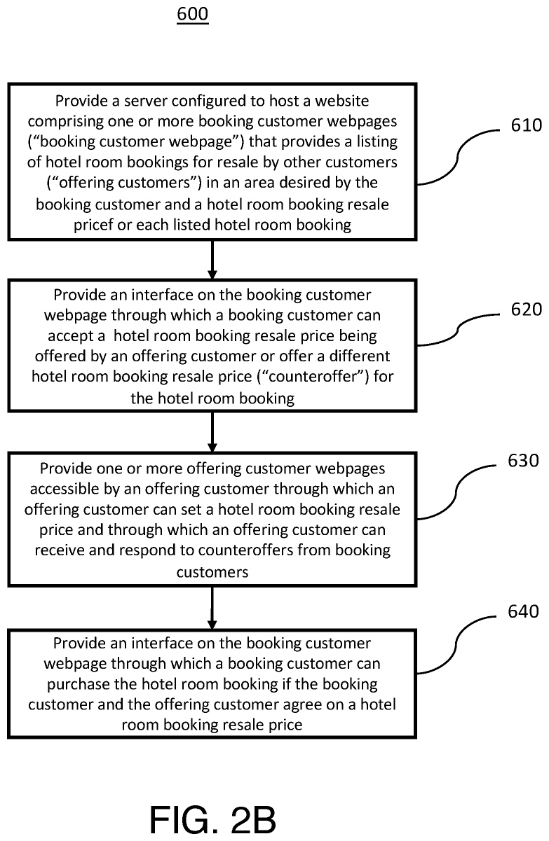

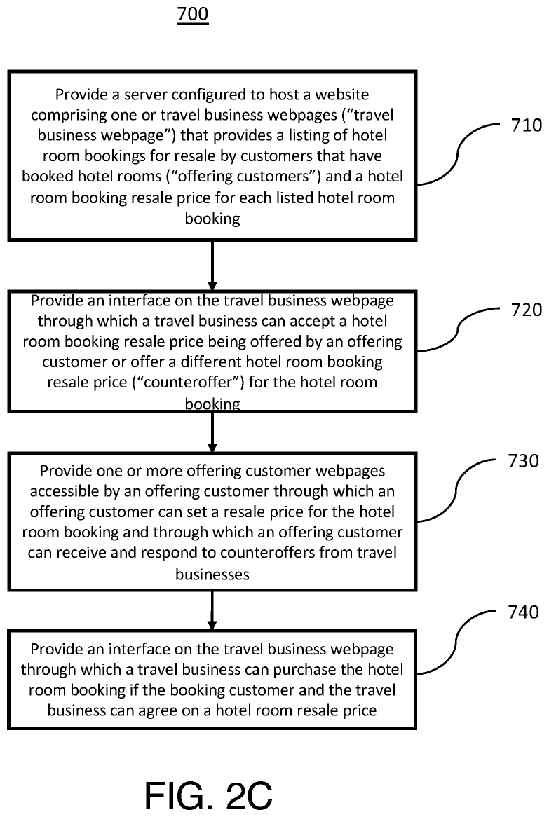

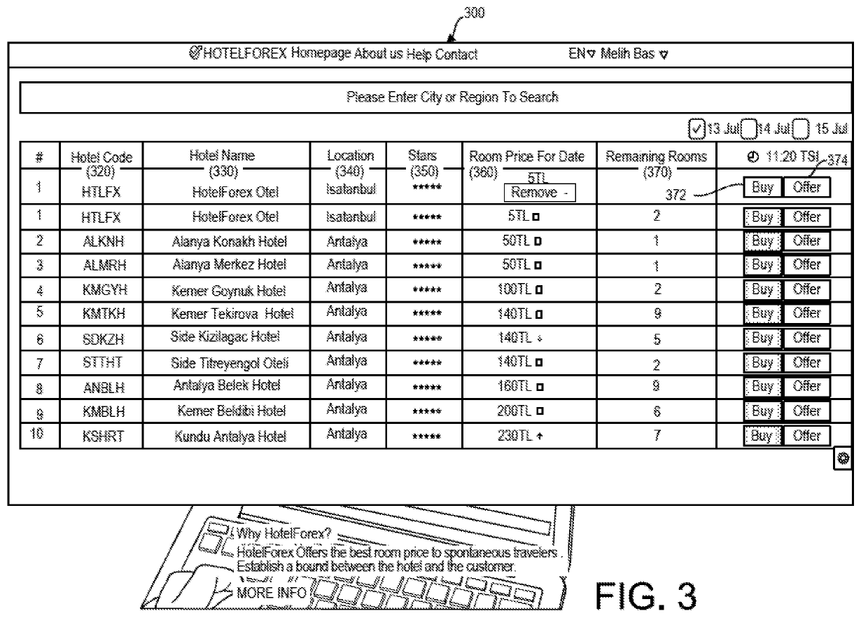

FIG. 2A is a flow chart a method 200 for providing an online hotel room exchange, in accordance with one embodiment of the present invention. In the first step 210, a server 110 is provided that is configured to host one or more websites 130 that comprises one or more customer webpages (“customer webpage”) that provides a listing of hotels in an area desired by the customer and a room rate for each listed hotel. The website 130 may be any set of interconnected webpages (usually including a homepage and generally located on the server) and may be prepared and maintained as a collection of information by a person, group, or organization.

The website 130 may be configured to prompt a user to enter his or her user name and password information and may be capable of receiving and sending hypertext transfer protocol (HTTP) requests or a web container that generally provides an environment for servlets and Java Server Pages (JSP) to run. Additionally, the website 130 may gather browser history, internet protocol (IP) location, and other information from the user, and may provide additional promotional webpages to encourage users to revisit the website 130 and to keep the website relevant in searches by search engines.

At step 220, an interface is provided on the customer webpage through which a customer can accept a room rate being offered by a hotel or offer a different room rate (“counteroffer”) for that hotel. At step 230, a hotel webpage is provided that is accessible by the hotel through which the hotel can set a room rate and through which the hotel can receive and respond to counteroffers from customers. In a preferred embodiment, the hotel webpage also provides the hotel with information regarding the room rates being offered by competing hotels so that hotels will compete among each other for customers.

In one preferred embodiment, and as discussed above, hotels are provided with all the counteroffers for their rooms and can then choose to lower the room rate based on supply and demand In a preferred embodiment, the room rate set by the hotel cannot be changed for a predetermined period of time (e.g., 30 minutes). Thus, in this preferred embodiment, a hotel must wait for the predetermined period of time before changing the room rate. During this predetermined period of time, the hotel can continue to gather counteroffers from customers. Once the predetermined period of time has elapsed, the hotel can then change the rate based on market conditions determined by the counteroffers it has received and, optionally, by considering the room rates being offered by other hotels.

In one preferred embodiment, and as discussed above, if the hotel lowers the room rate in response to market conditions (e.g., counteroffers, room rates being offered by other hotels), then all pending customer counteroffers that are equal to or higher than the new room rate set by the hotel are accepted at the new lower room rate set by the hotel. In addition, all other customers looking for hotel rooms are preferably offered the same new lower room rate for that hotel.

At step 240, an interface is provided on the customer webpage through which a customer can book a room at a hotel if the customer and the hotel agree on a room rate. In one embodiment, the customer and hotel are deemed to agree on a room rate if: (a) the customer accepts the room rate currently set by the hotel; or (b) if the hotel adjusts the room rate to an amount equal to or lower than a pending counteroffer from the customer. The interface prompts the customer to input details of the booking, such as number of rooms, check in and check out dates, number of guests, payment information, etc.

The present invention has been described above in connection with an online exchange between customers and hotels (B2C). However, as indicated above, the present invention can also implement an online exchange between customers (C2C) and an online exchange between customers and travel businesses (C2B).

FIG. 2B is a flow chart of a method 600 for providing a C2C online hotel room exchange, in accordance with one embodiment of the present invention. In a C2C exchange, the hotel device 160 in FIG. 1 is replaced with another customer device 150.

In the first step 610, a server 110 is provided that is configured to host one or more websites 130 that comprises one or more booking customer webpages (“booking customer webpage”) that provides a listing of hotel room bookings for resale by other customers that have booked hotel rooms (“offering customers”) in an area desired by the booking customer and a hotel room booking resale price for each listed hotel room. The website 130 may be any set of interconnected webpages (usually including a homepage and generally located on the server) and may be prepared and maintained as a collection of information by a person, group, or organization.

The website 130 may be configured to prompt a user to enter his or her user name and password information and may be capable of receiving and sending hypertext transfer protocol (HTTP) requests or a web container that generally provides an environment for servlets and Java Server Pages (JSP) to run. Additionally, the website 130 may gather browser history, internet protocol (IP) location, and other information from the user, and may provide additional promotional webpages to encourage users to revisit the website 130 and to keep the website relevant in searches by search engines.

At step 620, an interface is provided on the customer webpage through which a customer can accept a hotel room booking resale price being offered by an offering customer or offer a different hotel room booking resale price (“counteroffer”) for the hotel room. At step 630, an offering customer webpage is provided that is accessible by the offering customer through which the offering customer can set a hotel room booking resale price and through which the offering customer can receive and respond to counteroffers from booking customers. In a preferred embodiment, the offering customer webpage also provides the offering customer with information regarding the hotel room booking rates being offered by other offering customers so that offering customers will compete among each other for booking customers.

In one preferred embodiment, offering customers are provided with all the counteroffers for their hotel room bookings and can then choose to lower the hotel room booking resale price based on supply and demand.

At step 640, an interface is provided on the booking customer webpage through which a booking customer can purchase the hotel room booking if the booking customer and the offering customer agree on a hotel room booking resale price. In one embodiment, the booking customer and the offering customer are deemed to agree on a hotel room booking resale price if: (a) the booking customer accepts the hotel room booking resale price currently set by the offering customer; or (b) if the offering customer adjusts the hotel room booking resale price to an amount equal to or lower than a pending counteroffer from the booking customer.

FIG. 2C is a flow chart of a method 700 for providing a C2B online hotel room booking exchange, in accordance with one embodiment of the present invention. In a C2B exchange, the hotel device 160 in FIG. 1 is replaced with another customer device 150.

In the first step 710, a server 110 is provided that is configured to host one or more websites 130 that comprises one or more travel business webpages (“travel business webpage”) that provides a listing of hotel room bookings for resale by customers that have booked hotel rooms (“offering customers”) in an area desired by the travel business and a hotel room booking resale price for each listed hotel room. The website 130 may be any set of interconnected webpages (usually including a homepage and generally located on the server) and may be prepared and maintained as a collection of information by a person, group, or organization.

The website 130 may be configured to prompt a user to enter his or her user name and password information and may be capable of receiving and sending hypertext transfer protocol (HTTP) requests or a web container that generally provides an environment for servlets and Java Server Pages (JSP) to run. Additionally, the website 130 may gather browser history, internet protocol (IP) location, and other information from the user, and may provide additional promotional webpages to encourage users to revisit the website 130 and to keep the website relevant in searches by search engines.

At step 720, an interface is provided on the travel business webpage through which a travel business can accept a hotel room booking resale price being offered by an offering customer or offer a different hotel room booking resale price (“counteroffer”) for the hotel room. At step 730, an offering customer webpage is provided that is accessible by the offering customer through which the offering customer can set a hotel room booking resale price and through which the offering customer can receive and respond to counteroffers from travel businesses. In a preferred embodiment, the offering customer webpage also provides the offering customer with information regarding the hotel room booking rates being offered by other offering customers so that offering customers will compete among each other for booking customers.

In one preferred embodiment, offering customers are provided with all the counteroffers for their hotel room bookings and can then choose to lower the hotel room booking resale price based on supply and demand.

At step 740, an interface is provided on the travel business webpage through which a travel business can purchase the hotel room booking if the travel business and the offering customer agree on a hotel room booking resale price. In one embodiment, the travel business and the offering customer are deemed to agree on a hotel room booking resale price if: (a) the travel business accepts the hotel room booking resale price currently set by the offering customer; or (b) if the offering customer adjusts the hotel room booking resale price to an amount equal to or lower than a pending counteroffer from the travel business.

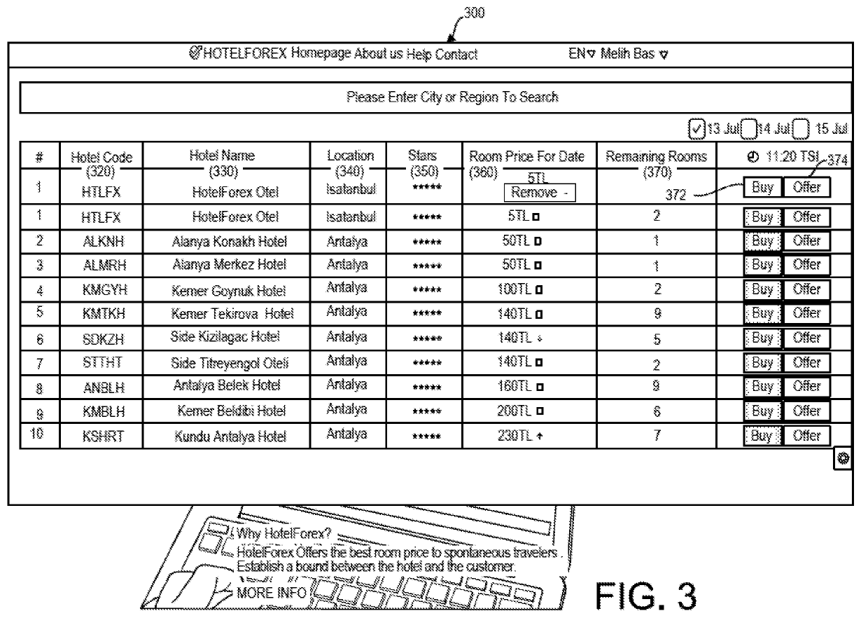

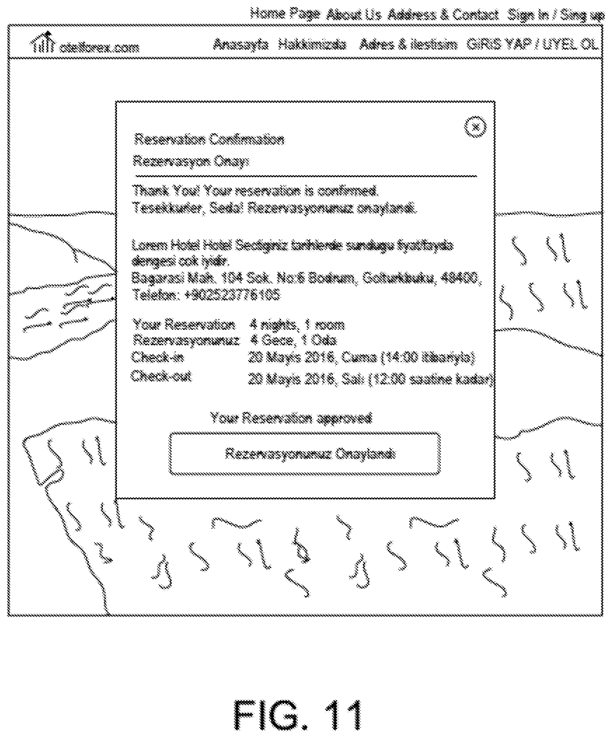

FIGS. 3-10 are sample screenshots of customer webpages and FIGS. 11-13 are sample screenshots of hotel webpages from an exemplary website 130, illustrating an example of how customers and hotels interact with the online hotel room exchange implemented by the system 100 for a B2C exchange between hotel room providers and customers. The screenshots are labeled in Turkish, however, English translations of certain phrases have been provided next to the Turkish phrases where necessary to describe certain aspects of the invention.

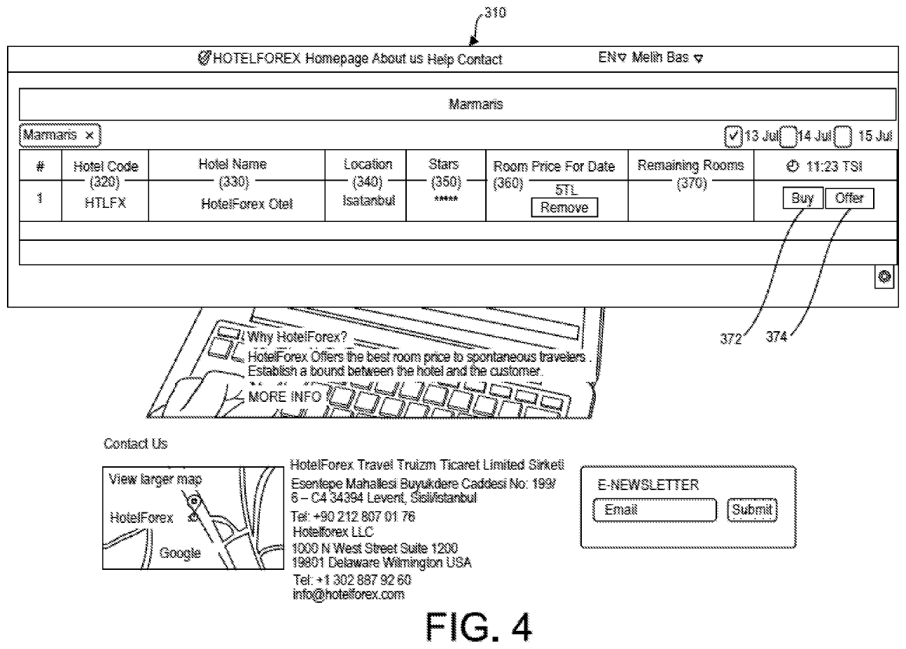

FIG. 3 is a screenshot of a webpage 300 presented to customers that includes a search function for searching available hotel rooms. The customer can search by geographic area or city. FIG. 4 is a screenshot of a webpage 310 showing hypothetical results for a search in the Turkish city of Marmaris.

The webpages 300, 310 shown in FIGS. 3 and 4 lists the hotel codes 320, hotel names 330, location of the hotels 340, star rating of the hotels 350, the current rate per night being offered by the hotel 360, and the number of rooms left (rooms that are still available for booking) 370. The hotels set a rate for the rooms they have available. In a preferred embodiment, the rate set by the hotel cannot be changed for a predetermined period of time (e.g., 30 minutes). Thus, the “Room Price For Date” 360 shown to the customer on the webpages preferably remain constant for a predetermined period of time.

The dates and number of nights that customers can book rooms for can be limited or can be unlimited. For example, the exchange module 120 can be adapted to only give customers the option of booking a maximum of three nights lodging within 12 months of the booking date. Any restrictions on the number of nights that can be booked and/or how far in the future the booking can be made for can be implemented. Alternatively, there could be no restrictions on the number of nights that can be booked and/or how far in the future the booking can be made.

The order in which the hotel rooms are listed on the webpages is preferably based on price. In a preferred embodiment, the lowest priced rooms are preferably listed in a higher position than higher priced rooms. Thus, the lowest priced room is listed at the top of the list, and the highest priced room is listed at the bottom of the list.

In a preferred embodiment, indicators are provided next to the “Room Price For Date” (rate per night) 360 that indicate a price trend. For illustrative purposes, it is assumed that the predetermined period of time that hotels must keep an offer price for a room constant is 30 minutes. An upward facing arrow indicates that the last time that the hotel adjusted room rate they lowered the price, and thus their position on the list went up. A downward facing arrow indicates that the last time that the hotel adjusted the room rate they increased the price, and thus their position on the list went down. A square indicates that after the predetermined period of time over which hotels must keep their room rate constant, the hotel kept the room rate the same. Thus, this mimics a “ticker tape” in a traditional securities market.

Customers have the following options when viewing the real-time or near real-time price information for the rooms they are interested in: (1) the customer can choose to book a room at the current price (by clicking the “Buy” button 372); (2) the customer can choose to make a lower offer for the room (“counteroffer”) by clicking the “Make Offer” button 374; or (3) the customer can choose to wait for the predetermined period of time before the hotel can change the room rate to see if the price of the desired room goes down.

If the customer chooses to make a counteroffer, the hotel will be provided with their offer, as well as the counteroffers from other customers. This will give the hotel information regarding supply and demand that they can use to determine whether or not to adjust room rate after the predetermined period of time has elapsed. In a preferred embodiment, if the hotel lowers the room rate in response to market conditions (e.g., counteroffers, room rates being offered by other hotels), then all pending customer counteroffers that are equal to or higher than the new room rate set by the hotel are accepted at the new lower room rate set by the hotel. In addition, all other customers looking for hotel rooms are preferably offered the same new lower room rate for that hotel.

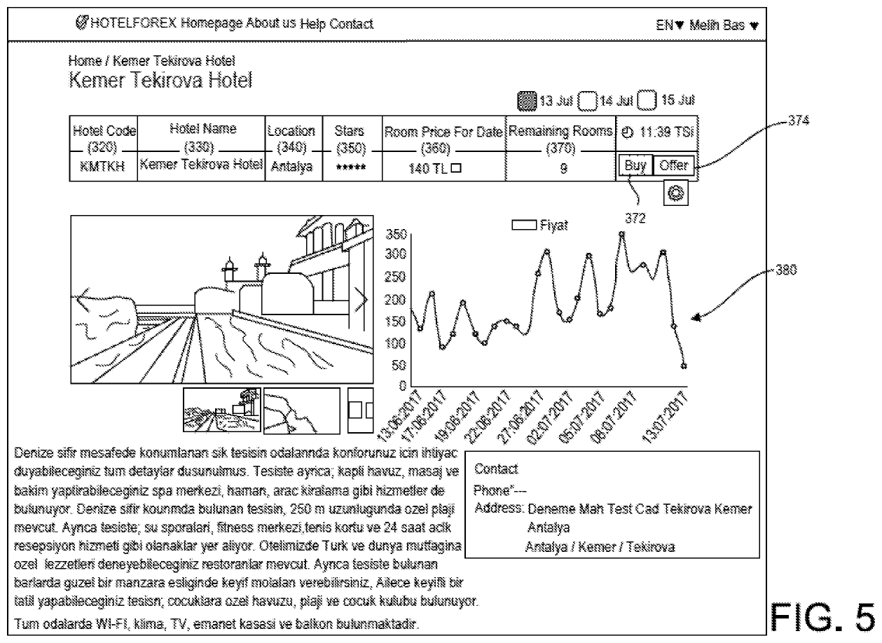

If a customer clicks (chooses) a room they are interested in, they are preferably presented with the webpage shown in FIG. 5, which preferably provides the customer with information about the hotel. In a preferred embodiment, this information includes a price history chart 380 for the hotel room the customer is interested in.

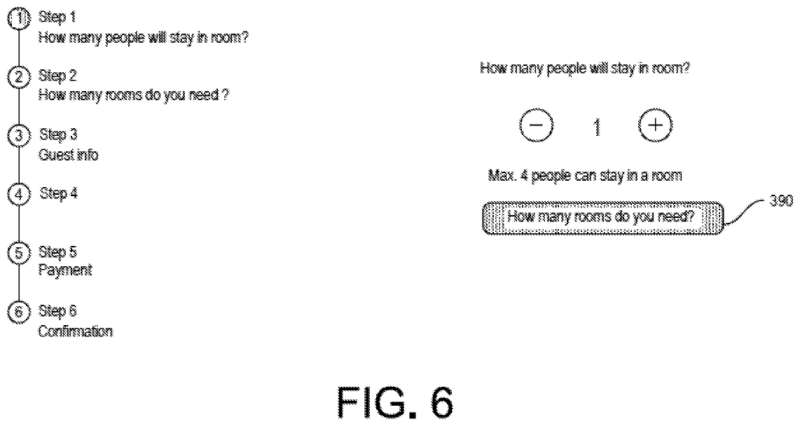

If the customer chooses to book the room by clicking on the “Buy” button 372 or a customer's counteroffer is accepted, the customer is preferably presented with the webpage shown in FIG. 6, which prompts the customer to enter the number of people that will be staying. In the illustrated example, the number of people can be indicated by using the “+” and “−” buttons. Once the number of people is indicated by the customer, the user can click on the “How many rooms do you need?” button 390 to proceed with the booking process.

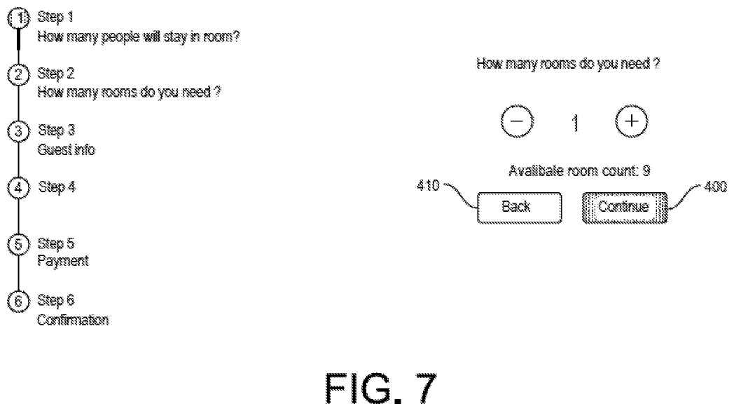

When the customer clicks on the “How many rooms do you need?” button 390, they are preferably presented with the webpage shown in FIG. 7, which prompts the customer to indicate the number of rooms they need. In the illustrated example, the number of rooms can be indicated by using the “+” and “−” buttons. Once the number of rooms is indicated by the customer, the user can click on the “continue” button 400 to proceed with the booking process, or can click the “back” button 410 to go back to the previous screen.

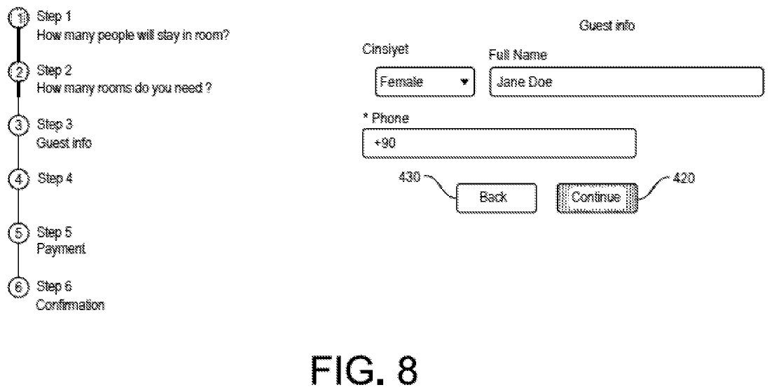

When the customer clicks on the “continue” button 400 in the screen shown in FIG. 7, the customer is preferably presented with the webpage shown in FIG. 8, which prompts the customer to enter information for the guests that will be staying. Once the guest information is entered, the customer can click on the “continue” button 420 to proceed with the booking process, or can click the “back” button 430 to go back to the previous screen.

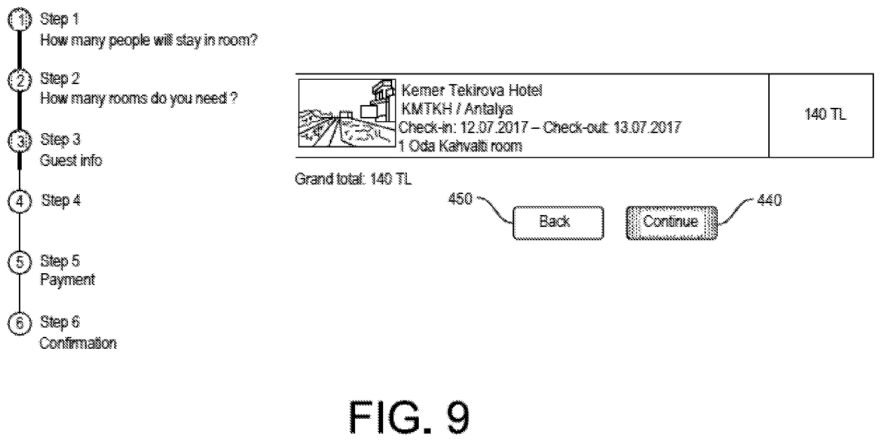

When the customer clicks on the “continue” button 420 in the screen shown in FIG. 8, the customer is preferably presented with the webpage shown in FIG. 9, showing the reservation details for the hotel. The customer can click on the “continue” button 440 to proceed with the booking process, or can click the “back” button 450 to go back to the previous screen.

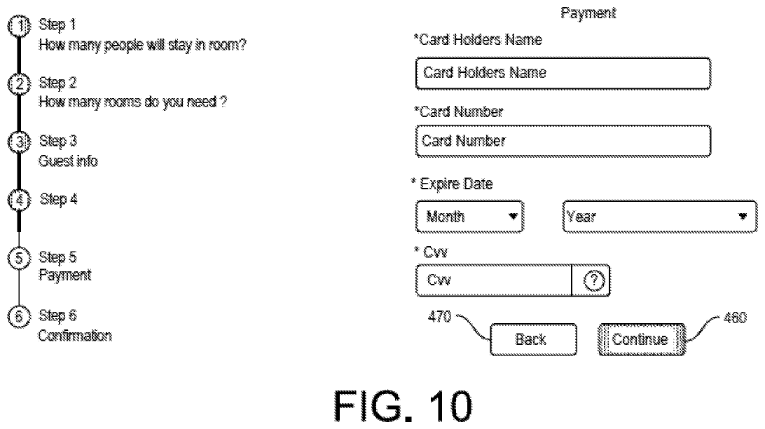

When the customer clicks on the “continue” button 440 in the screen shown in FIG. 9, the customer is preferably presented with the webpage shown in FIG. 10, which prompts the customer to provide their payment details (e.g., credit card information). Once the customer provides the payment details, they can click on the “continue” button 460 to proceed with the booking process, or can click the “back” button 470 to go back to the previous screen.

When the customer clicks on the “continue” button 460 in FIG. 10, the customer is preferably presented with the webpage shown in FIG. 11, showing a reservation confirmation that preferably includes the number of rooms, the number of nights booked, the check-in date and the check-out date.

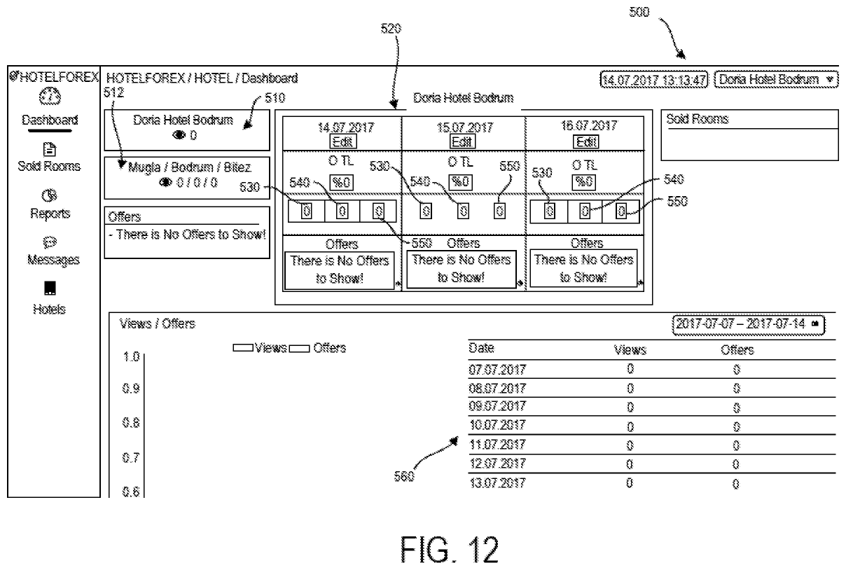

FIG. 12 is a screenshot of a webpage accessible by hotels for monitoring price offers for rooms, monitoring room bookings, setting the price for rooms, generating reports and obtaining other information regarding the market for rooms.

FIG. 12 shows a screenshot of a “dashboard” webpage 500 for a specific hotel. In the example shown, the hotel name is “Doris Hotel Bodrum.” In a preferred embodiment, the webpage 500 has an area 510 that shows the number of customers currently viewing the hotel's information on the customer webpage, and an area 512 that shows the number of customers viewing hotel listings in a particular geographical areas. There is preferably also an area 520 where the hotel can set the price of rooms for different dates. For each date, there are preferably areas that show the total number of rooms at the hotel 530, the number of rooms booked 540 and the number of rooms available to book 550. In a preferred embodiment, there is also a table 560 that lists the number of customer views and offers for previous dates.

As discussed above, a key aspect of the present invention is providing real-time or near real-time information to customers and hotels regarding the supply and demand for rooms (e.g., rooms available, current asking price for rooms, alternative price offers for rooms by customers, price being offered by competing hotels, etc.), thereby creating a real-time or near real-time market for lodging. Although not shown, the hotel webpage preferably also provides the hotel with information regarding the room rates being offered by competing hotels so that hotels will compete among each other for customers.

As discussed above, although the present invention has been described in the context of an online marketplace between customers and hotels, the present invention can also be adapted to provide a secondary marketplace between customers that want to resale bookings. For example, if a customer secures a booking for one or more rooms with a hotel, the exchange module 120 can be adapted such that the customer can offer the room(s) that they booked to other customers. Thus, the exchange module 120 can be adapted to provide a resale market between a customer that has secured a booking and other customers that are searching for rooms. In one embodiment, the hotel receives a percentage of revenues generated whenever a customer resells a booked hotel room to another customer via the online exchange.

The foregoing embodiments and advantages are merely exemplary, and are not to be construed as limiting the present invention. The description of the present invention is intended to be illustrative, and not to limit the scope of the claims. Many alternatives, modifications, and variations will be apparent to those skilled in the art. Various changes may be made without departing from the spirit and scope of the invention. For example, the screenshots of webpages shown in the figures are merely illustrative and can be modified (e.g., the layout, buttons, etc.) while still falling within the scope of the present invention.

What is claimed is:

1. A system for providing on online hotel room exchange, comprising:
a server; and
an exchange module comprising a set of computer readable instructions executable by the server to provide an online hotel room exchange between customers that have booked hotel rooms (“offering customers”) and customers seeking hotel rooms (“booking customers”) in which the offering customers and the booking customers can dynamically negotiate a resale price for booked hotel rooms;
wherein the online hotel room exchange provides the booking customer with the identity and location of hotel rooms prior to the booking customer initiating a resale price negotiation process for a booked hotel room.

2. The system of claim 1, wherein the exchange module comprises a set of computer readable instructions executable by the server to:
provide a website comprising one or more webpages accessible by the booking customer (“booking customer webpage”) that provides the following information: (a) a listing of hotel room bookings for resale; and (b) a resale price for a hotel room booking (“resale price”) for each of the listed hotel room bookings, wherein the resale price for each of the listed hotel room bookings is provided to the exchange module by offering customers;
provide an interface on the booking customer webpage through which a booking customer can: (a) accept a resale price being offered by an offering customer; or (b) offer a different resale price (“counteroffer”) for the hotel room booking;
provide one or more webpages accessible by offering customers (“offering customer webpage”) through which offering customers can set a hotel room booking resale price and through which offering customers can receive and respond to counteroffers from booking customers; and
provide an interface on the booking customer webpage through which a booking customer can purchase a hotel room booking if the booking customer and the offering customer agree on a resale price.

3. The system of claim 2, wherein the booking customer webpage provides booking customers with historical room rate information for each listed hotel room booking.

4. The system of claim 2, wherein the offering customer webpage provides offering customers with information regarding the hotel room booking resale prices being offered by competing offering customers.

5. The system of claim 2, wherein a pending booking customer counteroffer for a hotel room booking is deemed accepted if the offering customer sets a new hotel room booking resale price for the hotel room booking that is equal to or lower than the pending booking customer counteroffer.

6. A system for providing on online hotel room exchange, comprising:
a server; and
an exchange module comprising a set of computer readable instructions executable by the server to provide an online hotel room exchange between customers that have booked hotel rooms (“offering customers”) and travel businesses seeking hotel rooms (“travel businesses”) in which the offering customers and the travel businesses can dynamically negotiate a resale price for booked hotel rooms;
wherein the online hotel room exchange provides the travel businesses with the identity and location of hotel rooms prior to the travel businesses initiating a resale price negotiation process for a booked hotel room.

7. The system of claim 6, wherein the exchange module comprises a set of computer readable instructions executable by the server to:
provide a website comprising one or more webpages accessible by the travel businesses (“travel business webpage”) that provides the following information: (a) a listing of hotel room bookings for resale; and (b) a resale price for a hotel room booking (“resale price”) for each of the listed hotel room bookings, wherein the resale price for each of the listed hotel room bookings is provided to the exchange module by offering customers;
provide an interface on the travel business webpage through which a travel business can: (a) accept a resale price being offered by an offering customer; or (b) offer a different resale price (“counteroffer”) for the hotel room booking;
provide one or more webpages accessible by offering customers (“offering customer webpage”) through which offering customers can set a hotel room booking resale price and through which offering customers can receive and respond to counteroffers from travel businesses; and
provide an interface on the travel business webpage through which a travel business can purchase a hotel room booking if the travel business and the offering customer agree on a resale price.

8. The system of claim 7, wherein the travel business webpage provides travel businesses with historical room rate information for each listed hotel room booking.

9. The system of claim 7, wherein the offering customer webpage provides offering customers with information regarding the hotel room booking resale prices being offered by competing offering customers.

10. The system of claim 7, wherein a pending travel business counteroffer for a hotel room booking is deemed accepted if the offering customer sets a new hotel room booking resale price for the hotel room booking that is equal to or lower than the pending travel business counteroffer.
